(19) United States
(12) Patent Application Publication
(10) Pub. No.: US 2010/0295730 A1
(43) Pub. Date: Nov. 25, 2010

(54) METHOD FOR TRANSMITTING A SIGNAL IN A MULTIPLE INPUT MULTIPLE OUTPUT SYSTEM, AND AN APPARATUS FOR THE SAME

(76) Inventor: Beom Jin Jeon, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/864,487

(22) PCT Filed: Jan. 23, 2009
(86) PCT No.: PCT/KR2009/000371

§ 371 Date: Jul. 23, 2010

(30) Foreign Application Priority Data
Jan. 23, 2008 (KR) 10-2008-0006926

(51) Int. Cl. H04B 7/04

(52) U.S. Cl. 342/372

(57) ABSTRACT

A method for transmitting a signal in a MBVD system is disclosed. A method for transmitting a signal in Multiple Input Multiple Output (MIMO) system includes, transmitting a training signal based on a predetermined sequence via at least one beamforming antenna group, the beamforming antenna group including a plurality of antennas, receiving first information indicating at least one available beamforming antenna group from among the beamforming antenna groups, and transmitting second information and antenna weight information, the second information indicating beamforming antenna group being determined on the basis of the first information, the antenna weight information being associated with a signal transmitted from the antenna group indicated by the second information.

### TECHNICAL FIELD

The present invention relates to a Multiple Input Multiple Output (MIMO) system, and more particularly to a method for transmitting a signal via a beamforming antenna group in the MIMO system, and an apparatus for the same.

### BACKGROUND ART

In recent times, with the widespread of information communication technologies, a variety of multimedia services and a variety of high-quality services have been developed and introduced to the market, so that demands of wireless communication services are rapidly increasing throughout the world. In order to actively cope with the increasing demands, capacity of a communication system must be increased and a reliability of data transmission must also be increased.

A variety of methods for increasing communication capacity under wireless communication have been considered, for example, a method for searching for a new available frequency band in all frequency bands, and a method for increasing efficiency of given resources. In one example of the latter method, a transceiver may include a plurality of antennas to additionally guarantee a spatial area utilizing resources so that a diversity gain can be acquired. In another example of the latter method, Multiple Input Multiple Output Antenna (hereinafter referred to as MIMO) communication technologies for increasing transmission capacity by transmitting data via individual antennas in parallel have recently been developed by many companies or developers.

### DISCLOSURE OF INVENTION

### Technical Problem

Accordingly, the present invention is directed to a method for transmitting a signal in a multiple input multiple output (MIMO) system that substantially obviates one or more problems due to limitations and disadvantages of the related art.

An object of the present invention is to provide a method for transmitting a signal via a beamforming antenna group in a MIMO system.

### Technical Solution

To achieve these objects and other advantages and in accordance with the purpose of the invention, as embodied and broadly described herein, a method for transmitting a signal in Multiple Input Multiple Output (MIMO) system comprises: transmitting a training signal based on a predetermined sequence via at least one beamforming antenna group, the beamforming antenna group including a plurality of antennas.

The method may further comprise; receiving first information indicating at least one available beamforming antenna group from among the beamforming antenna groups; and transmitting second information and antenna weight information, the second information indicating beamforming antenna group being determined on the basis of the first information, the antenna weight information being associated with a signal transmitted from the antenna group indicated by the second information.

The antenna weight information may be applied to the determined beamforming antenna group, thereby forming a signal having directivity.

The antenna weight information may be applied to the determined beamforming antenna group, thereby implementing an antenna diversity.

The antenna weight information may include antenna weight information of a transmission unit and antenna weight information of a reception unit.

The method for transmitting the signal may be periodically performed during a predetermined time.

The method for transmitting the signal may be repeated a predetermined number of times.

The method may further comprise: if a communication failure occurs in a communication mode between a transmission unit and a reception unit communicating with each other via the determined beamforming antenna group, resuming the communication mode via another beamforming antenna group indicated by the first information.

The method may further comprise: performing a tracking operation, the tracking operation adaptively adjusting an antenna weight value according to a communication status while a transmission unit communicates with a reception unit via the determined beamforming antenna group.

The tracking operation may be performed for each beamforming antenna group.

The signal transmitted via the beamforming antenna group may be an “mmWave” signal.

To achieve these objects and other advantages and in accordance with the purpose of the invention, as embodied and broadly described herein, and apparatus for SUBSTITUTE SHEET (RULE 26) transmitting a signal in Multiple Input Multiple Output (MIMO) system comprises: an antenna configured to transmit data and configured to receive data.

The apparatus may further comprise; a controller configured to control to transmit a training signal based on a predetermined sequence via at least one beamforming antenna group, the beamforming antenna group including a plurality of antennas, configured to control to receive first information indicating at least one available beamforming antenna group from among the beamforming antenna groups, and configured to control to transmit second information and antenna weight information, the second information indicating beamforming antenna group being determined on the basis of the first information, the antenna weight information being associated with a signal transmitted from the antenna group indicated by the second information.

The antenna weight information may include antenna weight information of the transmission unit and antenna weight information of the reception unit.

The signal transmitted via the beamforming antenna group may be an “mmWave” signal.

### ADVANTAGEOUS EFFECTS

The method for transmitting a signal in a MIMO system according to the present invention selects a beamforming antenna group and transmits a signal via the selected beamforming antenna group. As a result, the present invention forms a beam capable of minimizing an interference degree, and transmits data using this beam, such that it can improve a communication performance.

The present invention is able to transmit a signal having directivity via the selected beamforming antenna group. In addition, the present invention is able to perform a diversity scheme or a MIMO scheme using a plurality of selected beamforming antenna groups.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a block diagram illustrating a transmission/reception unit including a plurality of antennas under a wireless network environment;

FIG. 2 is a block diagram illustrating a transmission/reception unit including a plurality of antennas under a wireless network environment according to the present invention;

FIG. 3 is a flow chart illustrating a method for transmitting a signal via a beamforming antenna group according to the present invention;

FIG. 4 is a flow chart illustrating a communication resuming method under a communication failure according to the present invention; and

FIG. 5 is a flow chart illustrating a beam-tracking process under a communication mode according to the present invention.

### BEST MODE FOR CARRYING OUT THE INVENTION

To achieve these objects and other advantages and in accordance with the purpose of the invention, as embodied and broadly described herein, a method for transmitting a signal in Multiple Input Multiple Output (MIMO) system comprises: forming at least one beamforming antenna group having a plurality of antennas forming a beam, transmitting a training signal based on a predetermined sequence via the antennas contained in the beamforming antenna group.

The method may further comprise; receiving first information indicating at least one available beamforming antenna group from among the beamforming antenna groups; and transmitting second information and antenna weight information, the second information indicating beamforming antenna group being determined on the basis of the first information, the antenna weight information being associated with the second information.

The apparatus may further comprise; a controller configured to control to forming several beamforming antenna groups, each of which including a plurality of antennas forming a beam, configured to control to transmit a training signal based on a predetermined sequence via the antennas contained in each beamforming antennas group, configured to control to receive first information indicating at least one available beamforming antenna group from among the beamforming antenna groups, and configured to control to transmit second information and antenna weight information, the second information indicating beamforming antenna group being determined on the basis of the first information, the antenna weight information being associated with the second information.

### MODE FOR THE INVENTION

Reference will now be made in detail to the preferred embodiments of the present invention, examples of which are illustrated in the accompanying drawings.

FIG. 1 is a block diagram illustrating a transmission/reception unit including a plurality of antennas under a wireless network environment.

Referring to FIG. 1, a transmission unit includes a plurality of transmitters 10, and a reception unit includes a plurality of receivers (not shown) and reception (Rx) MIMO processor 15 for detecting a transmission (Tx) signal.

Under a limited channel bandwidth environment, a MIMO technology may be applied to each of the transmission unit and the reception unit. According to this MIMO scheme, each of the transmission and reception units includes a plurality of transceivers (e.g., a plurality of antennas), and transmits data packets using the antennas. The MIMO scheme includes a plurality of antennas in each of the transmission and reception units, and applies a variety of MIMO techniques to the transmission and reception units, such that the individual antennas simultaneously transmit data in parallel. The MIMO scheme may transmit different data packets to increase the efficiency of data transmission, or may obtain an antenna diversity gain by transmitting the same data packets via different antennas.

Theoretically, since data packets are simultaneously transmitted via N transmitters 10 and N receivers (not shown), it is expected that a data rate will increase N times. However, channels between the N transmitters 10 and the N receivers (not shown) may have interference. In order to solve the interference, a complicated decoding, a filtering, and a detection algorithm may be added to each of the transmission unit and the reception unit, such that the increase of the data rate is reduced as much as the added information.

Therefore, if independent channels are formed and a mutual interference between individual channels is removed without the channel overlapping, and if the channels can be adaptively controlled under a variable fading environment, the effect of capacity enhancement can be maximized, a reception unit is easily constructed, such that a MIMO effect can be increased.

The present invention provides a method for installing an antenna array transmitting directional signals into each of a transmission unit and a reception unit in order to form independent channels, minimizing interference by properly controlling the independent channels, and at the same time stabilizing a MIMO effect by adaptively controlling a channel environment change. A detailed description of the method of the present invention will hereinafter be described with reference to the annexed drawings.

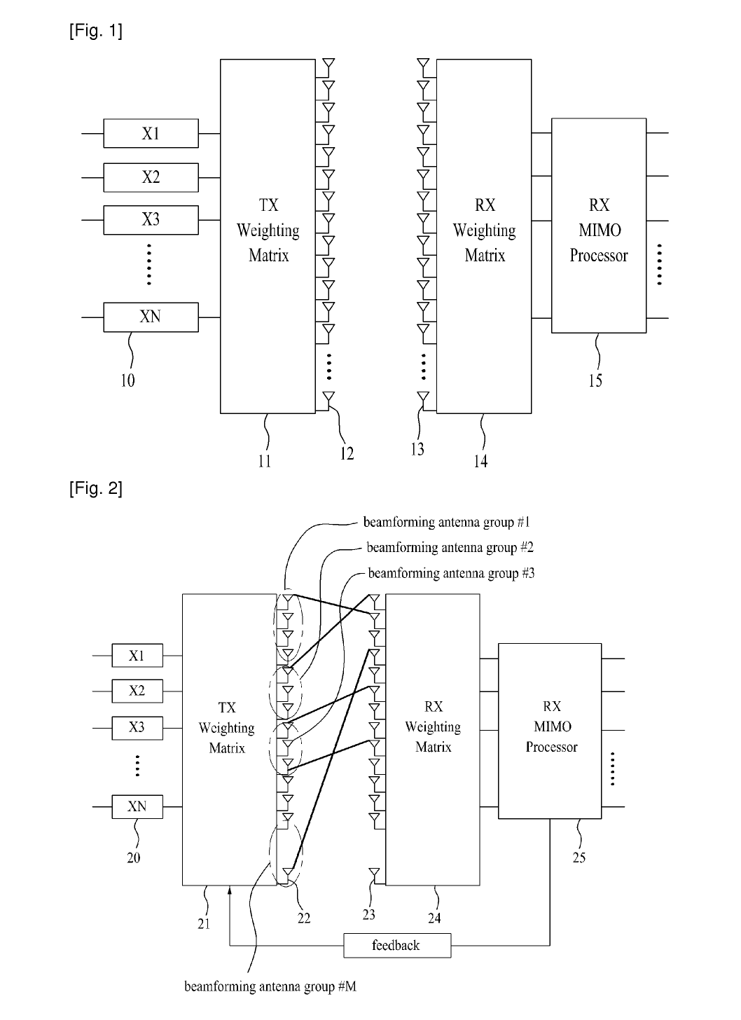

FIG. 2 is a block diagram illustrating a transmission/reception unit including a plurality of antennas under a wireless network environment according to the present invention.

Referring to FIG. 2, the transmission unit includes a plurality of transmitters 20, a first weighting unit 21 for weighting signal sequences generated from the transmitters 20, and a plurality of antennas. The reception unit includes a plurality of antennas, a second weighting unit 24 for weighting signal sequences received from the antennas, and a reception (Rx) MIMO processor 25 for detecting a transmission (Tx) signal.

The antennas contained in each of the transmission and reception units may construct one or more groups according to the present invention. In this case, each group is indicative of an antenna array for forming a directional signal (i.e., a beam), and includes one or more antennas. The antenna array forming a specific beam will hereinafter be defined as a beamforming antenna group.

As can be seen from FIG. 2, a total of M beamforming antenna groups are constructed. In this case, each beamforming antenna group may include the same number of antennas, and individual groups may have a different number of antennas. A series of concatenated antennas may construct the antenna group as shown in FIG. 2, or the antenna group may also be composed of arbitrary dispersed antennas. In order to transmit the directional signal, it is preferable that a predetermined number of concatenated antenna sequences may construct a single group.

This beamforming antenna group may be fixed, or may be adaptively controlled according to a channel condition such that it can be reconstructed as a combination capable of maximizing capacity.

The present invention selects at least one beamforming antenna group from among several beamforming antenna groups, such that data packets can be transmitted via the selected beamforming antenna group. In addition, the present invention selects a plurality of beamforming antenna groups, such that it may transmit data packets via antennas contained in each beamforming antenna group.

In this case, as described above, it is preferable that each signal transferred via beamforming antenna groups may have directivity and interference between Tx signals of the individual beamforming antenna groups may be minimized. The above-mentioned situation may also correspond to another status in which a signal is transmitted via antenna arrays constructing each beamforming antenna group but the antenna arrays have different phases.

In order to transmit data packets using the directional signal via antennas contained in one or two beamforming antenna groups, it is preferable that an appropriate weight may be assigned to each of the transmission and reception units. In other words, this embodiment may assign appropriate weights to the transmission/reception units. By the appropriate weights, this embodiment can form an optimum beam appropriate for a current channel condition and can minimize interference between Tx signal beams transmitted via individual groups.

The following equation 1 represents an example of a reception (RX) signal of the reception unit in consideration of a weight to be applied to this reception unit.

[Math FIG. 1]

R=(WᵣH Wₜ)+W

In Equation 1, R is a reception (Rx) signal vector, X is a transmission (Tx) signal vector, W is noise, Wt is a weight vector which applies a weight to the transmission unit, and Wr is a weight vector which applies a weight to the reception unit. H is random MIMO channel characteristics. If the number of Tx antennas is M and the number of Rx antennas is N, H may be represented by an (M×N) matrix. In this case, in case of transmitting a signal using some selected beamforming antenna groups, M or N may be limited to the number of Tx/Rx antennas contained in a corresponding group.

In this case, weight vector values are properly adjusted at the transmission/reception unit, such that interference between signals transferred via individual beamforming antenna groups can be minimized. The following Table 2 numerically represents an ideal case which has no interference by an adjusted weight.

$$[ \begin{matrix}R 1 \\ R 2 \\ R 3 \\ ⋮ \\ Rn\end{matrix} ] = [ \begin{matrix}0 & H 1 & 0 & … & 0 \\ 0 & 0 & H 2 & … & 0 \\ 0 & 0 & 0 & … & H 3 \\ ⋮ & ⋮ & ⋮ & ⋱ & ⋮ \\ Hn & 0 & 0 & … & 0\end{matrix} ] [ \begin{matrix}X 1 \\ X 2 \\ X 3 \\ ⋮ \\ Xn\end{matrix} ] + W \qquad [ Math Figure 2 ]$$

As can be seen from Equation 2, R1 is represented by an equation (R1=H1 X2+W2), R2 is represented by an equation (R2=H2 X3+W3), and R3 is represented by an equation (R3=H3 Xn+Wn, . . . Rn=HnX1+W1). That is, R1 may be affected by H1, R2 may be affected by H2, and R3 may be affected by H3, such that there is no interference effect. Under this situation, a reception unit may detect a Tx signal using a simple algorithm.

Although an interference component does not correctly reach zero (i.e., 0) as shown in Equation 2, an interference level between signals can be greatly reduced because each beamforming antenna group transmits a high-directivity signal. It is assumed that this interference level is 0, the Tx signal can be easily detected by the same algorithm as that of Equation 2. Needless to say, the present invention may use a modified algorithm in consideration of a predetermined interference.

In addition, in case of selectively using several beamforming antenna groups, a diversity scheme and/or a MIMO scheme is applied to data packets transmitted via individual beamforming antenna groups, such that capacity may be additionally increased and a diversity gain may also be obtained. In this case, various conventional schemes may be applied to the diversity scheme and/or the MIMO scheme, such that the diversity scheme and/or the MIMO scheme may use a single beamforming antenna group as a single antenna. That is, a directional signal (i.e., a signal having directivity) transmitted via each beamforming antenna group is used as a signal transmitted from a single antenna, such that the present invention may transmit this signal according to the diversity scheme and/or the MIMO scheme without considering interference among Tx antennas.

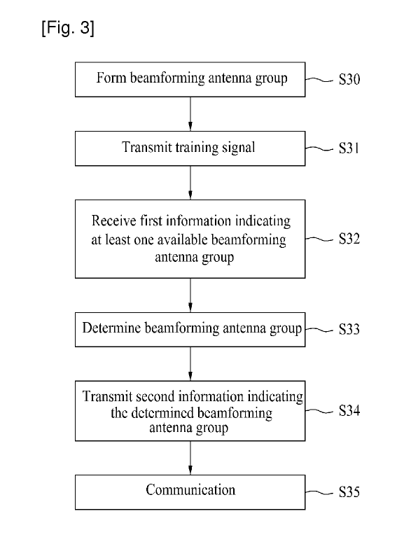

The following Equation 3 numerically represents an exemplary case in which the signal is transmitted according to the diversity scheme.

$$[ \begin{matrix}R 1 \\ R 2 \\ R 3 \\ ⋮ \\ Rn\end{matrix} ] = [ \begin{matrix}0 & H 11 + H 12 + H 13 & 0 & … & 0 \\ 0 & 0 & H 2 & … & 0 \\ 0 & 0 & 0 & … & H 3 \\ ⋮ & ⋮ & ⋮ & ⋱ & ⋮ \\ Hn & 0 & 0 & … & 0\end{matrix} ] [ \begin{matrix}X 1 \\ X 2 \\ X 3 \\ ⋮ \\ Xn\end{matrix} ] + W \qquad [ Math Figure 3 ]$$

In case of comparing “R1” of Equation 3 with that of Equation 2, Equation 3 considers at least three channels due to (H11+H12+H13) whereas Equation 2 considers only one channel (H1) due to (H1 X2+W), such that it can be recognized that a diversity can be applied to Equation 3.

In this case, an additional antenna weight may be used for the diversity scheme or the MIMO scheme. In this case, the antenna weight may be used separately from another weight which is used to transmit the directional signal via each beamforming antenna group.

Preferably, the antenna weight to be applied to either each antenna or each beamforming antenna group may be determined to be a specific value which can obtain an optimum gain from a current channel in consideration of a channel condition. In this way, in order to reflect a current channel condition in decision of a weight value, the reception unit may inform the transmission unit of channel information acting as feedback information, wherein the channel information has been recognized as a signal received from the transmission unit.

In other words, if channel status information, which has been determined on the basis of the Rx signal by the reception unit, is fed back from the reception unit to the transmission unit, the transmission unit can determine an optimum beamforming antenna group or its weight on the basis of feedback information.

FIG. 3 is a flow chart illustrating a method for transmitting a signal via a beamforming antenna group according to the present invention.

A method for selecting a beamforming antenna group from among several beamforming antenna groups and transmitting a signal via the selected beamforming antenna group according to the present invention will hereinafter be described with reference to FIG. 3.

Referring to FIG. 3, each device includes a plurality of antennas, and the antennas are constructed as one or more beamforming antenna groups at step S30. However, the above step S30 need not always be carried out whenever the beamforming antenna group is selected.

The transmission unit transmits a training signal via each beamforming antenna group at step S31. In this case, the training signal is based on a predetermined sequence shared between the transmission unit and the reception unit. This training signal may include identification information of the transmission unit as necessary.

In this case, it is preferable that Tx signals of several beamforming antenna groups contained in the transmission unit may be sequentially transmitted. That is, after a beamforming antenna group #1 transmits a signal, another beamforming antenna group #2 transmits a signal and then beamforming antenna groups can sequentially transmit a signal. Also, one or more beamforming antenna groups may transmit signals at intervals of a predetermined time as necessary.

The reception unit receives the above training signals such that it can perform channel estimation and signal detection. The reception unit feeds back the resultant information generated by the signal detection to the transmission unit, such that the transmission unit receives the above information and selects one or more beamforming antenna groups at step S32.

The reception unit may indicate the signal detection result in association with all or some beamforming antenna groups. In this case, the transmission unit selects a single optimum beamforming antenna group from among beamforming antenna groups, each of which has a high performance higher than a reference performance, according to the aforementioned signal detection result. As a result, at step 33, the transmission unit is able to determine one or more beamforming antenna groups.

In the meantime, information transmitted from the reception unit may directly indicate information of a beamforming antenna group which transmits a signal having a quality higher than a reference quality or may also indicate other information of any available beamforming antenna group. For example, the above information may indicate index information assigned to each beamforming antenna group. In case of using the above-mentioned method for indicating the information of the available beamforming antenna group, an amount of feedback information can be greatly reduced as compared to the above method for directly feeding back the detection result.

In this case, the transmission unit receives information of a beamforming antenna group available for the above step S32, for example, one or more beamforming antenna group indexes. The transmission unit may decide one or more beamforming antenna groups to be used at step S33. In this case, Rx information of the transmission unit of the above step S32 may include beamforming antenna group information and the above-mentioned detection result (i.e., Rx-signal intensity information).

In addition, the beamforming antenna group to be used can be selected at step S33, and a weight to be applied to the selected beamforming antenna group can also be determined at step S33. That is, weight values to be applied to Tx/Rx signals of the transmission/reception units can be determined on the basis of the Rx-signal intensity information.

The transmission unit informs the reception unit of beamforming antenna group information at step S34. In this case, information of the weight value applied to the reception unit may also be notified.

The above steps S31˜S34 may be repeated several times as necessary.

In this way, if at least one beamforming antenna group is selected in several beamforming antenna groups, a communication mode will be carried out using the selected beamforming antenna group at step S35. The method for selecting at least one beamforming antenna group from among several beamforming antenna groups shown in FIG. 3 may be called a beam searching process. This beam searching process may be carried out at an initial time of the communication mode or may also be carried out during the communication mode.

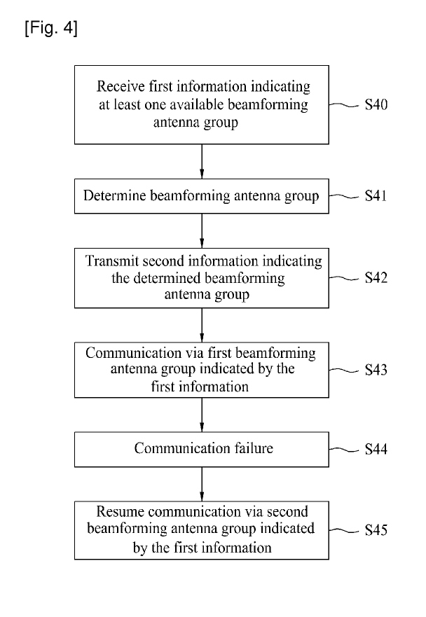

FIG. 4 is a flow chart illustrating a communication resuming method under a communication failure according to the present invention.

Referring to FIG. 4, the transmission unit receives first information including information of at least one available beamforming antenna group from the reception unit at step S40, such that at least one beamforming antenna group is decided at step S41. Determined information (i.e., second information) is transmitted to the reception unit at step S42. The steps S40, S41, and S42 of FIG. 4 are substantially equal to those of FIG. 3. However, the beamforming antenna group having been determined at step S41 will hereinafter be referred to as a first beamforming antenna group, differently from that of FIG. 3.

An unexpected obstacle occurs while the communication mode between the transmission unit and the reception unit is carried out using the first beamforming antenna group at step S43, such that a radio environment is changed due to the obstacle and the communication mode may be suspended at step S44. In this case, at step S45, the transmission unit may resume the suspended communication mode using another beamforming antenna group (i.e., a second beamforming antenna group) contained in the first information having been received at the above step S45.

If the beam searching process of FIG. 3 is periodically carried out, the first information received at the above step S40 may be updated, and one of beamforming antenna groups contained in the updated first information may be selected such that the communication mode may resume via the selected beamforming antenna group.

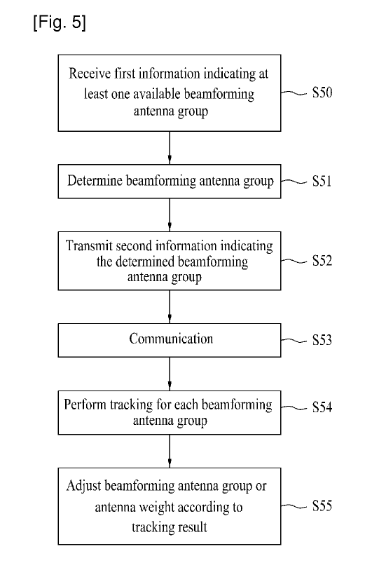

FIG. 5 is a flow chart illustrating a beam-tracking process under a communication mode according to the present invention.

In FIG. 5, the beam-tracking process indicates a method for adaptively determining an antenna weight according to a channel environment changeable during the communication mode. Detailed operations of the beam-tracking process may be similar to those of the beam searching process of FIG. 3. However, it is very important that the above operation of the beam-tracking process must be quickly carried out during the communication mode. Therefore, this embodiment is characterized in that the above operations ara carried out within a current beamforming antenna group instead of all beamforming antenna groups.

In more detail, the transmission unit receives first information including information of at least one available beamforming antenna group from the reception unit at step S50. The transmission unit determines at least one beamforming antenna group at step S51, and transmits the determined information (i.e., second information) to the reception unit at step S52. The above steps S50, S51, and S52 are substantially equal to those of FIG. 3.

While the communication mode is carried out using the determined beamforming antenna group at step S53, the beam-tracking process is performed on antennas contained in a current beamforming antenna group. As a result, the number of antennas used for the beam-tracking can be minimized, such that a time needed for the tracking can be reduced.

The above tracking process may be similar to the beam-searching process as described above. In more detail, if the training signal is transmitted via antennas contained in a beamforming antenna group (specifically, the current beamforming antenna group being used), the reception unit receives the above-mentioned training signal. The reception unit performs channel estimation and detection processes on the basis of the received signal, such that it may inform the transmission unit of either the channel estimation and detection result or optimum weight information. The transmission unit receives this information from the reception unit, adjusts its own weight on the basis of the received information, and applies a signal using the adjusted weight.

Preferably, the above-mentioned signal transmission method may be applied to an “mmWave” signal having high directivity.

It is obvious to those skilled in the art that claims having no explicit citation relationships are combined with each other to implement the embodiments, or new claims obtained by the amendment after the patent application may also be contained in the present invention without departing from the scope and spirit of the present invention.

The above-mentioned terms may be replaced with others as necessary. For example, a user device may also be replaced with a device, a user equipment, or a station and an adjustment device may also be replaced with a control apparatus, an adjuster (or a controller), an adjusting device (or a controlling device), a coordinator, or a piconet coordinator (PNC). Also, the data packet is a general term of Tx/Rx information (e.g., messages, traffic, video/audio data packets, and control data packets), and it is not limited to only a specific data packet and can also be applied to other examples.

There are a variety of devices capable of performing the communication mode in a communication system, for example, a computer, a PDA, a notebook, a digital TV, a camcorder, a digital camera, a printer, a microphone, a speaker, a headset, a barcode reader, a display, a mobile phone, etc. All kinds of digital devices may be used as the above devices.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents. Therefore, the above-mentioned detailed description must be considered for only illustrative purposes instead of restrictive purposes. The scope of the present invention must be decided by a rational analysis of claims, and all modifications within equivalent ranges of the present invention are contained in the scope of the present invention.

### INDUSTRIAL APPLICABILITY

As apparent from the above description, the present invention relates to a method for transmitting a signal via a beamforming antenna group, which can be applied to a MIMO system based on a beam link.

1. A method for transmitting a signal in Multiple Input Multiple Output (MIMO) system, comprising:
transmitting a training signal based on a predetermined sequence via at least one beamforming antenna group, the beamforming antenna group including a plurality of antennas;
receiving first information indicating at least one available beamforming antenna group from among the beamforming antenna groups; and
transmitting second information and antenna weight information, the second information indicating beamforming antenna group being determined on the basis of the first information, the antenna weight information being associated with a signal transmitted from the antenna group indicated by the second information.

2. The method according to claim 1, wherein the antenna weight information is applied to the determined beamforming antenna group, thereby forming a signal having directivity.

3. The method according to claim 1, wherein the antenna weight information is applied to the determined beamforming antenna group, thereby implementing an antenna diversity.

4. The method according to claim 1, wherein the antenna weight information includes antenna weight information of a transmission unit and antenna weight information of a reception unit.

5. The method according to claim 1, wherein the method for transmitting the signal is periodically performed during a predetermined time.

6. The method according to claim 1, wherein the method for transmitting the signal is repeated a predetermined number of times.

7. The method according to claim 1, further comprising:
if a communication failure occurs in a communication mode between a transmission unit and a reception unit communicating with each other via the determined beamforming antenna group, resuming the communication mode via another beamforming antenna group indicated by the first information.

8. The method according to claim 1, further comprising:
performing a tracking operation, the tracking operation adaptively adjusting an antenna weight value according to a communication status while a transmission unit communicates with a reception unit via the determined beamforming antenna group.

9. The method according to claim 8, wherein the tracking operation is performed for each beamforming antenna group.

10. The method according to claim 1, wherein the signal transmitted via the beamforming antenna group is an “mmWave” signal.

11. An apparatus for transmitting a signal in Multiple Input Multiple Output (MIMO) system, comprising:
an antenna configured to transmit data and configured to receive data; and
a controller configured to control to transmit a training signal based on a predetermined sequence via at least one beamforming antenna groups, the beamforming antenna group including a plurality of antennas, configured to control to receive first information indicating at least one available beamforming antenna group from among the beamforming antenna groups, and configured to control to transmit second information and antenna weight information, the second information indicating beamforming antenna group being determined on the basis of the first information, the antenna weight information being associated with a signal transmitted from the antenna group indicated by the second information.

12. The apparatus according to claim 11, wherein the antenna weight information includes antenna weight information of the transmission unit and antenna weight information of the reception unit.

13. The apparatus according to claim 11, wherein the signal transmitted via the beamforming antenna group is an “mmWave” signal.
